(19) United States
(12) Patent Application Publication
(10) Pub. No.: US 2014/0052651 A1
(43) Pub. Date: Feb. 20, 2014

(54) Method and System for Product Testing and Conformity Certification

(71) Applicant: Bureau Veritas, Neuilly sur Seine (FR)

(72) Inventors: Alan Howard Kirwilliam, Bury (GB); Rohit Kamat, Hong Kong (HK)

(21) Appl. No.: 13/942,834

(22) Filed: Jul. 16, 2013

Related U.S. Application Data
(60) Provisional application No. 61/684,142, filed on Aug. 17, 2012.

(51) Int. Cl. G06Q 30/00

(52) U.S. Cl. CPC G06Q 30/018
USPC 705/317

(57) ABSTRACT

A system and method for managing product documentation and certification, comprising: receiving product information of a product, wherein the product information comprises product identification and the conformance regulation that the product is to comply with; receiving the answers to one or more questions for categorizing products based on the product characteristics; determining product category of the product by using the answers, wherein the product category being selected from an hierarchy of product categories modeled after product categorization requirements of the conformance regulation that the product is to comply with; determining the rules according to the product category determined and the conformance regulations that the product is to comply with; identifying the laboratories for performing the conformance tests on the product according to the rules determined; receiving the documents required by the rules, wherein the documents comprises one or more conformance test results; and generating and preserving a general conformity certificate.

### CLAIM FOR DOMESTIC PRIORITY

This application claims priority under 35 U.S.C. §119 to the U.S. Provisional Utility Patent Application No. 61/684,142, filed Aug. 17, 2012, and the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to information systems used in product manufacturing, testing, quality control, quality assurance, logistics, and safety and regulation compliance certification processes. Particularly, the present invention relates to methods and systems for managing, collecting, and presenting data and documentation pertaining to product testing for safety and regulation compliance certification.

### BACKGROUND

To achieve scale of economy and cost efficiency, finished goods are often marketed, sold, and used in more than one economic or geographical market without extensive redesign for each market. This means that the goods must be designed to meet diverse sets of regulatory requirements in multiple jurisdictions at the time when the goods are imported into these markets. For example, a mobile communication device being sold in the United States and the European Union might have to meet the regulatory requirements set out by the Federal Communications Commission (FCC) in the U.S., the U.S. Consumer Product Safety Improvement Act (CPSIA), the Waste Electrical and Electronic Equipment Directive (WEEE) and the Restriction of Hazardous Substances Directive (RoHS) in the European Union. In addition, modern product manufacturing supply chains can span across multiple countries.

This means all components that might be sourced from multiple different countries must also be designed and manufactured to meet these regulatory requirements. Furthermore, products being imported and sold in different countries must have their samples tested, inspected, and/or factories audited, periodically in some cases, for compliance of the regulations in those countries. In some cases, a product that comprises multiple components sourced from multiple suppliers will also need to pass such compliance tests at the component level. In addition, these regulations often require certification of conformity by government-accredited institutes and documentation on the products.

During a product life cycle, a product can be updated, its components and suppliers could change, and so could the rules and regulations that the product must be compliant to. These events trigger the needs for renewed product testing, additional factory audits, re-certifications, and/or product documentation updates. Therefore, there is a need for a tool or a method that facilitate the storage, retrieval, and change management of product documentations including product specifications, production plans, test plans, test data, as well as certifications of conformance and their updates.

### SUMMARY

It is an objective of the presently claimed invention to provide a method and system that collect and manage data of certification of conformity and product documentation, and present in a plurality of different formats the up-to-date data and status of the certification and product documentation processes. Such method and system can be an integral part of product manufacturing, logistic, and/or quality control and assurance processes.

In accordance to one aspect of the presently claimed invention, the certification of conformity and product documentation management system receives the product information of a new product being entered by a user of the system. The product information can include product identification and the conformance regulation that the product is to comply with.

The system categorizes the new product based on a series of questions presented to the user, soliciting the detail information on the new product. The product category that the new product belongs to is determined based on the answers to these questions. In one embodiment, the product category is selected from a hierarchy of product categories that is modeled after the product categorization requirements of the product conformance regulation that the product is to comply with, such as those in the U.S. Consumer Product Safety Improvement Act (CPSIA).

For different categories of product, different sets of test, ban, and standard (“rules”) apply. The system determines the rules that apply to the new product based on its product category. The system then identifies the laboratories for performing the conformance tests on the new product demanded by the rules determined. Various documentations of various document types, including, but not limited to, the product specification and test results, are uploaded to the system.

Finally, a general conformity certificate is issued based on the product information, the product category, the rules determined, the laboratories identified, and the documentations uploaded. The general conformity certificate is stored within the system and made accessible to the user and the conformity certification authority. The system also generates a reference, such as a URL link or a Quick Response (QR) code that would direct an Internet browser to retrieve the electronic copy of the general conformity certificate.

In accordance to another aspect of the presently claimed invention, the system can accept more information on the new product than that demanded in the generation of the general conformity certificate. The additional information can include production data such as lot size. Using all the information used in generating the general conformity certificate and the additional information, the system generates a periodic/product test plan document that might be used to satisfy the supplementary documentary requirements of the conformance regulation, such as the “Reasonable Testing Program” imposed by the CPSIA.

In accordance to yet another aspect of the presently claimed invention, the certification of conformity and product documentation management system provides a workflow assignment automation process for automatically assigning product documentation tasks to different parties when a new product is entered into the system. Each user of the system can configure the level and settings of automation for her account in the system. In accordance to one embodiment, the user can designate one or more users of the system as Uploaders, Reviewers, and/or Approvers of documents at various stages of the product life cycle for each specified document type and product category.

The user decides on the documentation tasks for each document type to be 1-step (review and approval steps are not required), 2-step (after upload, only review or approval step is required), or 3-step (after upload, both review and approval steps are required) process. Uploaders are designated users for uploading the specified documentation such as the test results of certain tests demanded by a rule. As such, an Uploader user can be a supplier of the product. In this case, a supplier can perform its documentation task by using a specially designated user interface (“Supplier Portal”) of the system. Reviewers are designated users for reviewing the uploaded documentation, and Approvers are designated users for approving the uploaded documentation. In addition, the designated users, Uploaders, Reviewers, and/or Approvers, can be registered users (“subscribers”) or unregistered users (“Unsubscribers”) of the system.

### BRIEF DESCRIPTION OF THE DRAWINGS

Embodiments of the invention are described in more detail hereinafter with reference to the drawings, in which

FIGS. 1A-1I show the flow charts depicting an exemplary embodiment of the process flow of a determination process of product category and applicable rules from answers to a series of questions provided by the presently claimed certification of conformity and product documentation management system; and

FIG. 2 shows an exemplary general conformity certificate.

### DETAILED DESCRIPTION

In the following description, certification of conformity and product documentation management methods and systems for collecting and managing data of certification of conformity and product documentation, and presenting in a plurality of different formats the up-to-date data and status of the certification and product documentation processes and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In accordance to various embodiments, a user of the presently claimed certification of conformity and product documentation management system, through the use of a client computing device, makes requests for presentment or submission of data of product information, user selections, and documentations to a server application running in a processing server or cluster of processing servers with a user interface to be displayed on the client computing device.

The client computing device can be a conventional general purpose desktop or mobile computer, personal digital assistant, smart mobile phone, or any computing device with graphics display capability and is capable of processing computer data signals conforming to common data transmission protocols such as TCP/IP, HTTP, and HTML. The requests and responses between the client computing device and the processing server or cluster of processing servers is transmitted through wired and/or wireless communication medium. One such communication medium is the Internet.

The server application running at the processing server or cluster of processing servers collects from other internal and/or external processing servers for product information, user selection, and documentation data and preserves this data in a data repository, which can be residing in one or more of the processing server or cluster of processing servers or a separate processing server or cluster of processing servers. The user interacts with the client computing device through a user interface of the certification of conformity and product documentation management system. In accordance to various embodiments, such user interface can be an Internet browser application or a custom application running in the client computing device displaying one or more web applications or web pages hosted and executed by the processing server or cluster of processing servers.

In accordance to one aspect of the presently claimed invention, the certification of conformity and product documentation management system receives the product information of a new product being entered by a user of the system. The product information can include, but not limited to, product identification such as product name, model numbers, and SKU, product description, name and contact of supplier, manufacturer, and/or importer, date of manufacture, import date, country of origin, geography of sale, the conformance regulation that the product is to comply with, and the name and contact of the person maintaining the new product's record in the system.

The system categorizes the new product based on a series of questions presented to the user, soliciting the detail information on the new product. The questions can be about the targeted and foreseeable consumers and end users of the product, the usage of the product that is designed for, material and structure of the product. The product category that the new product belongs to is determined based on the answers to these questions. In one embodiment, the product category is selected from a hierarchy of product categories that is modeled after the product categorization requirements of the product conformance regulation that the product is to comply with, such as those in the U.S. Consumer Product Safety Improvement Act (CPSIA).

In accordance to one embodiment, through the use of the user interface, the user of the certification of conformity and product documentation management system can bypass the above product category determination step by mapping a product category to a new product being entered into the system if the product category is known to the user.

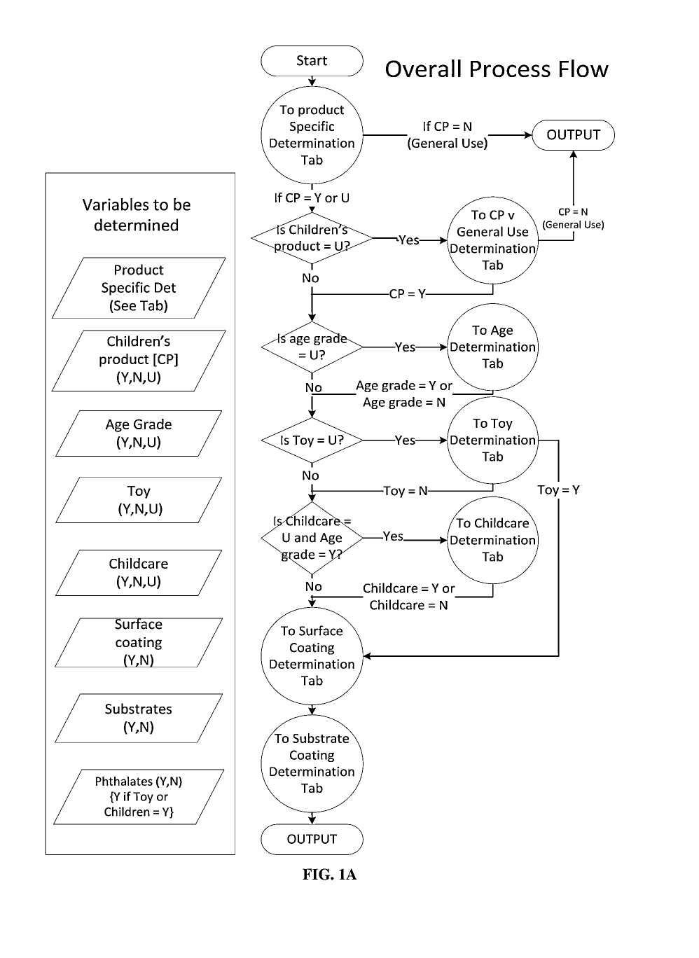

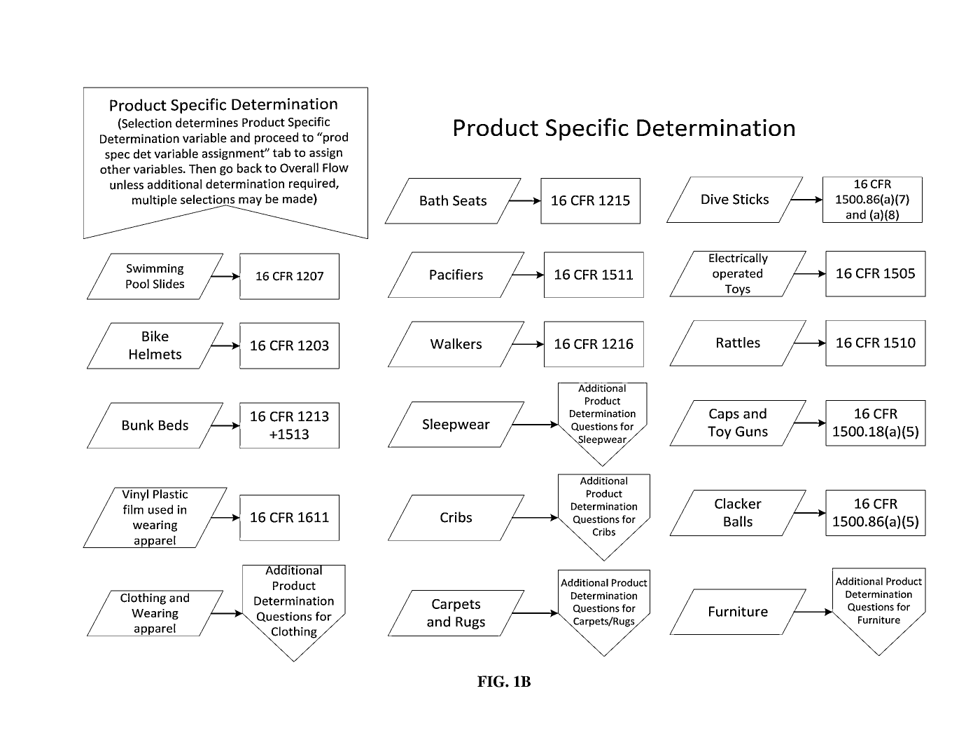

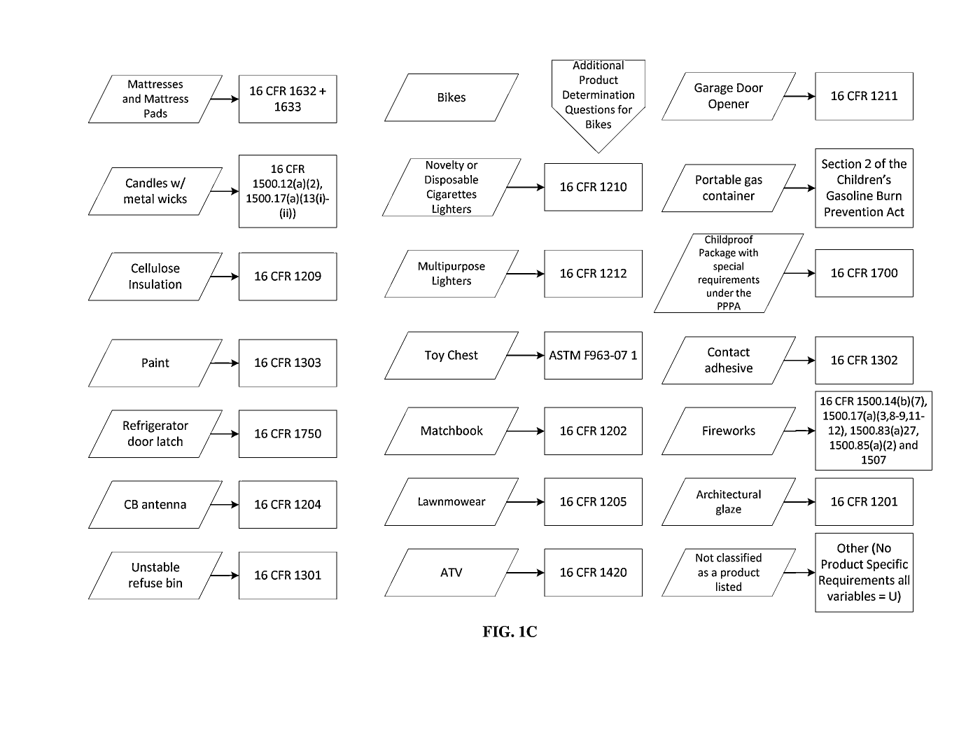

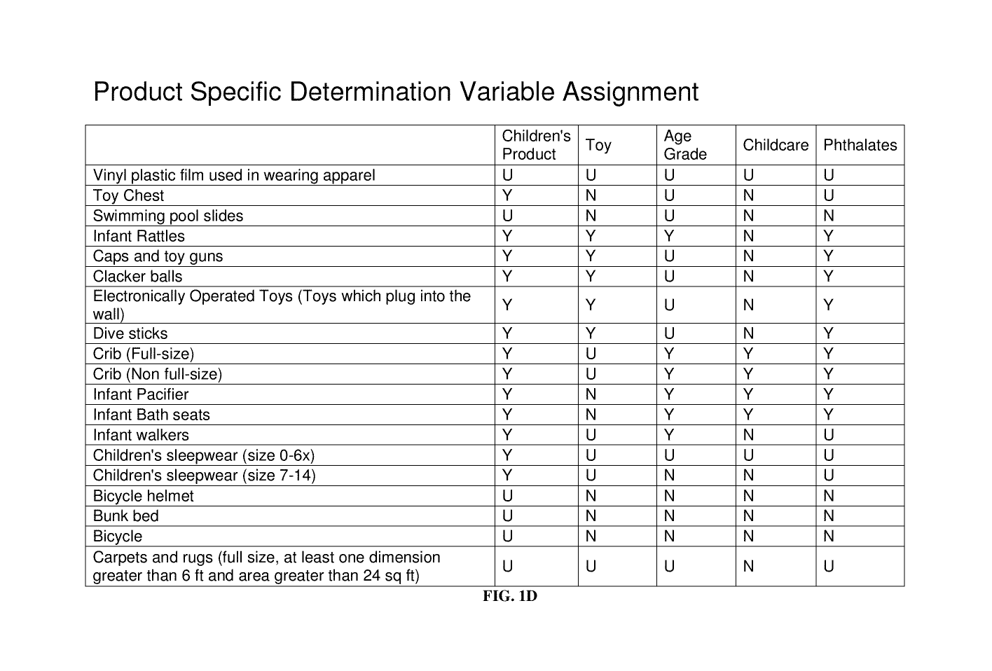

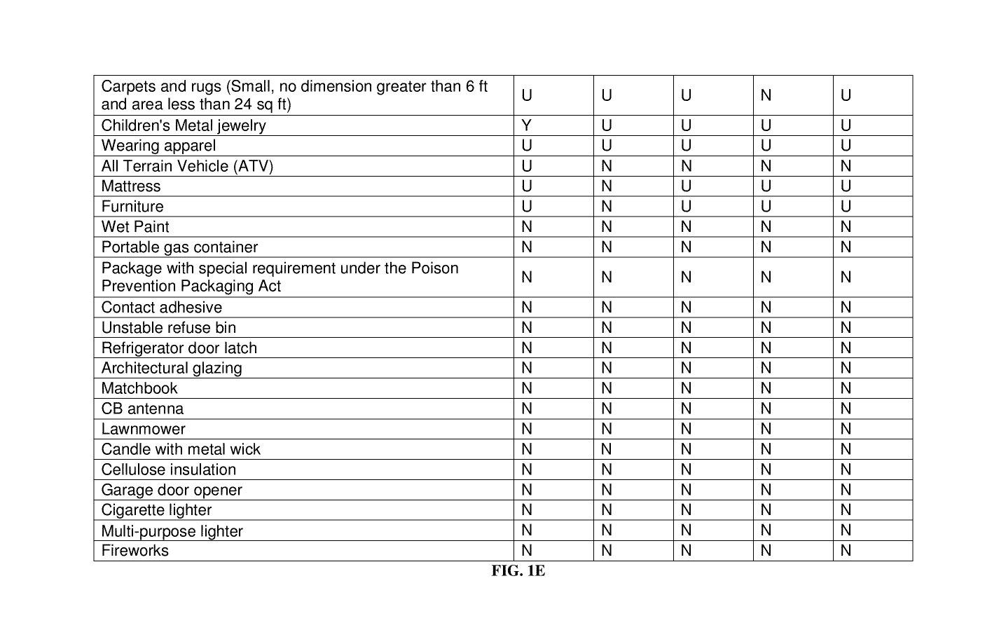

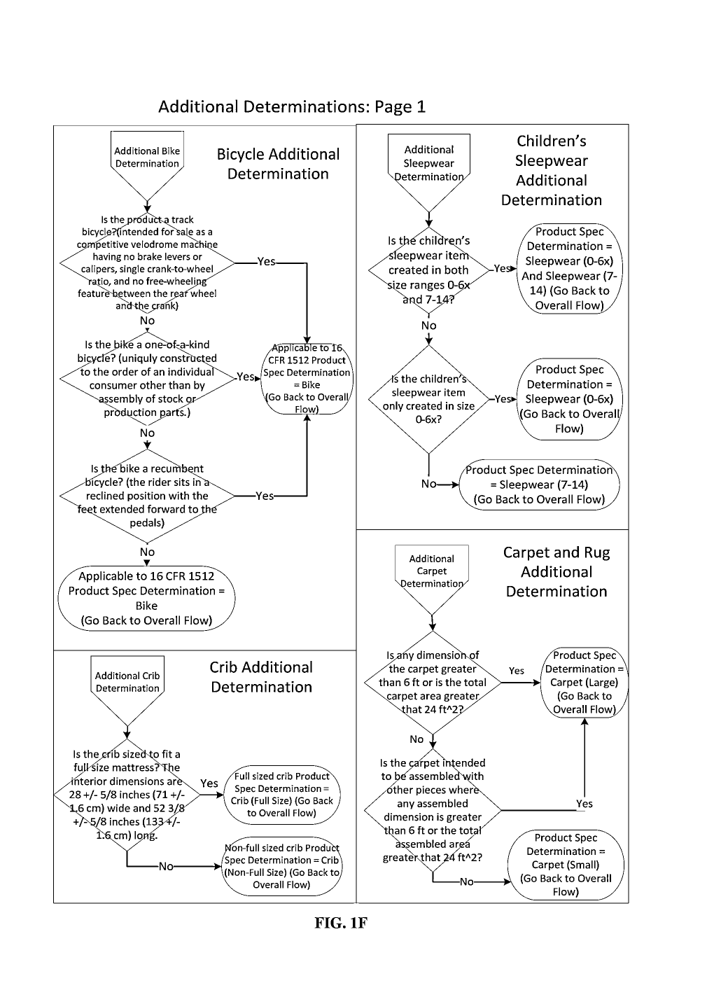

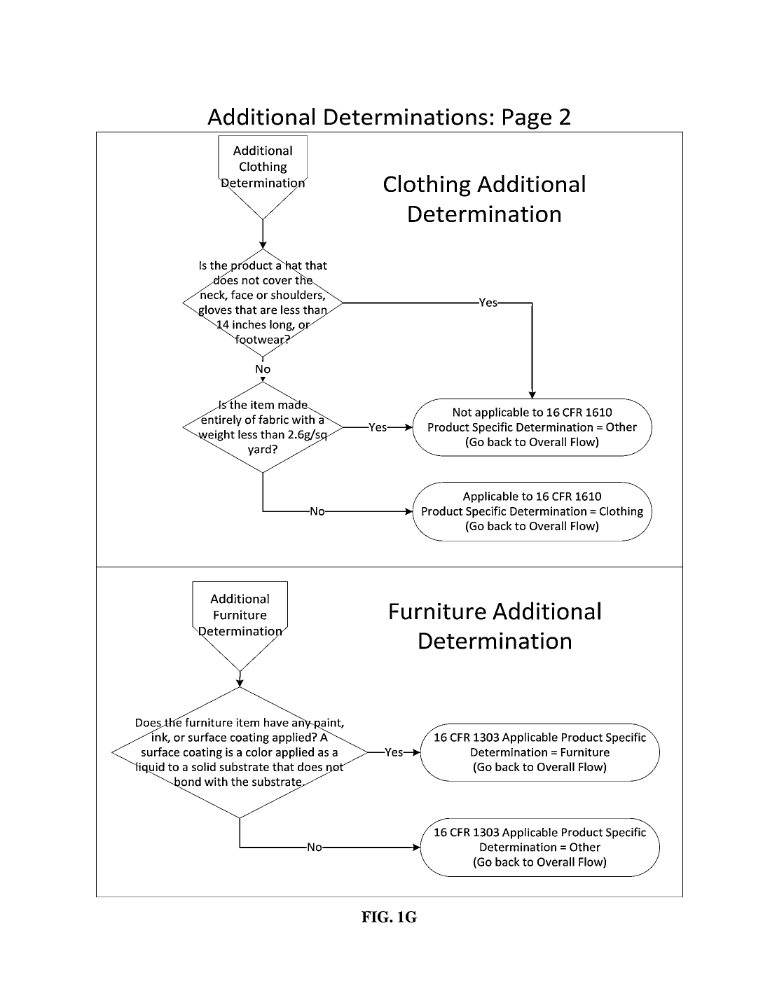

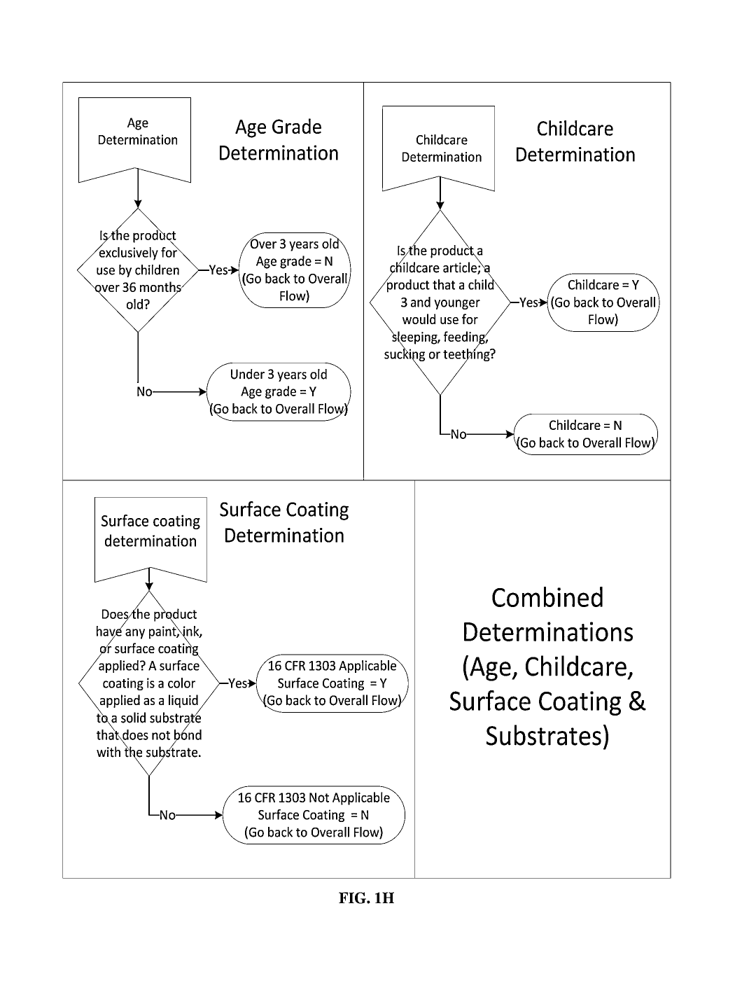

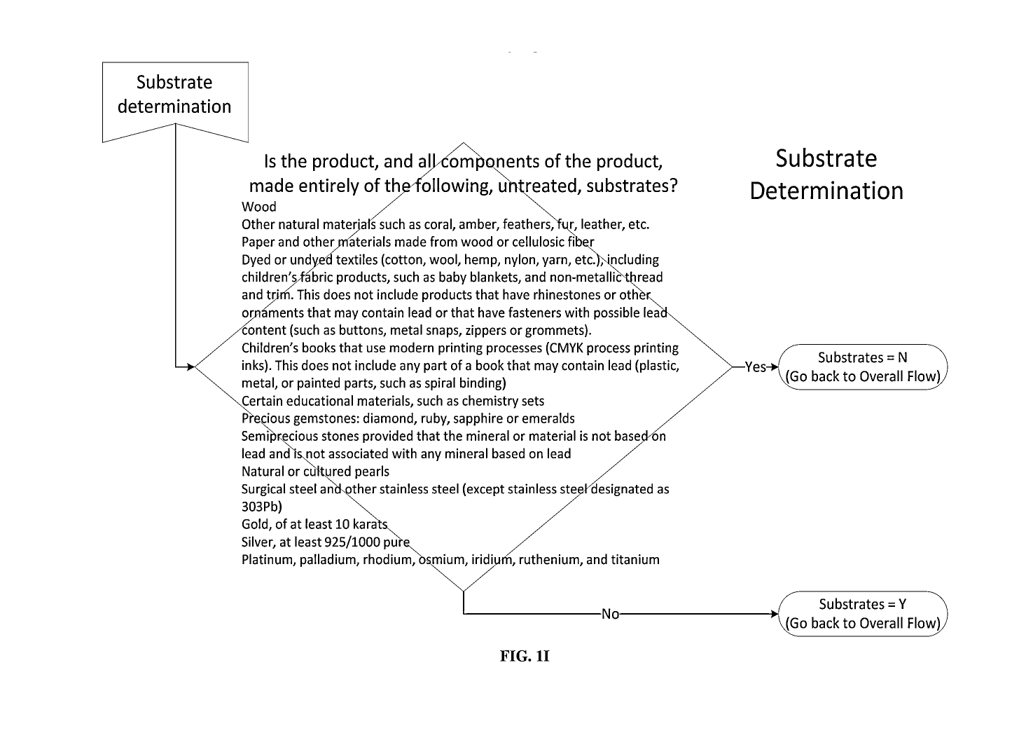

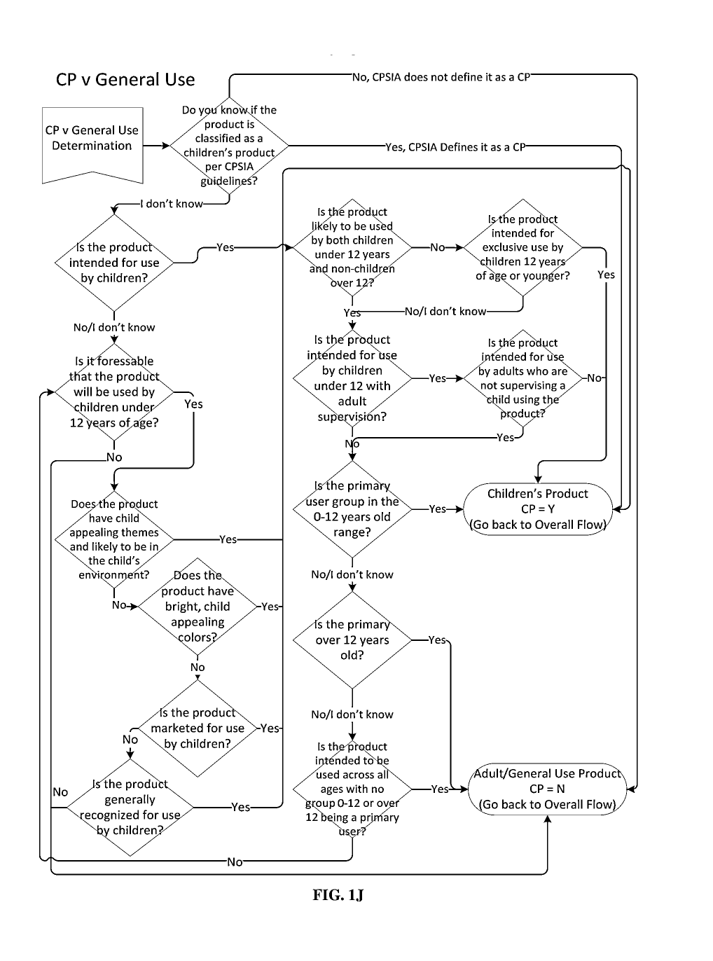

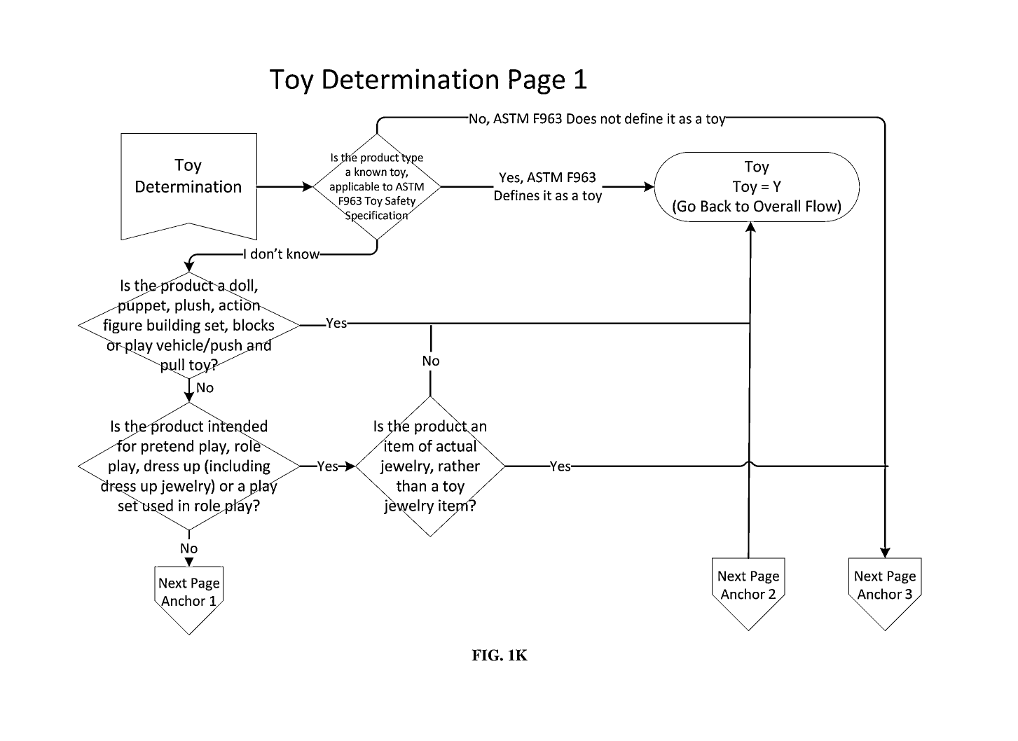

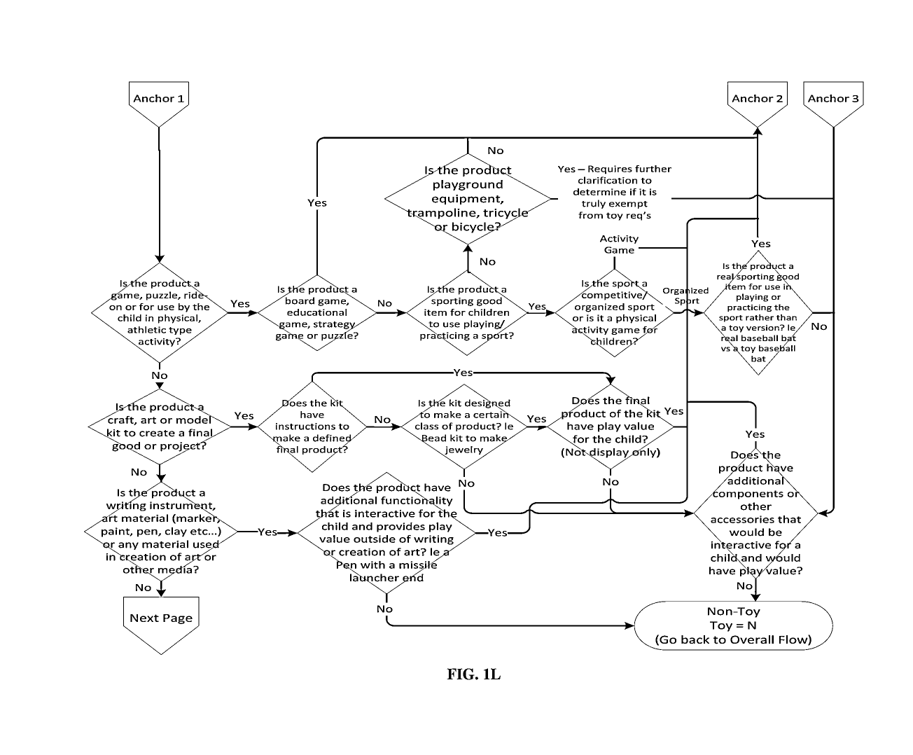

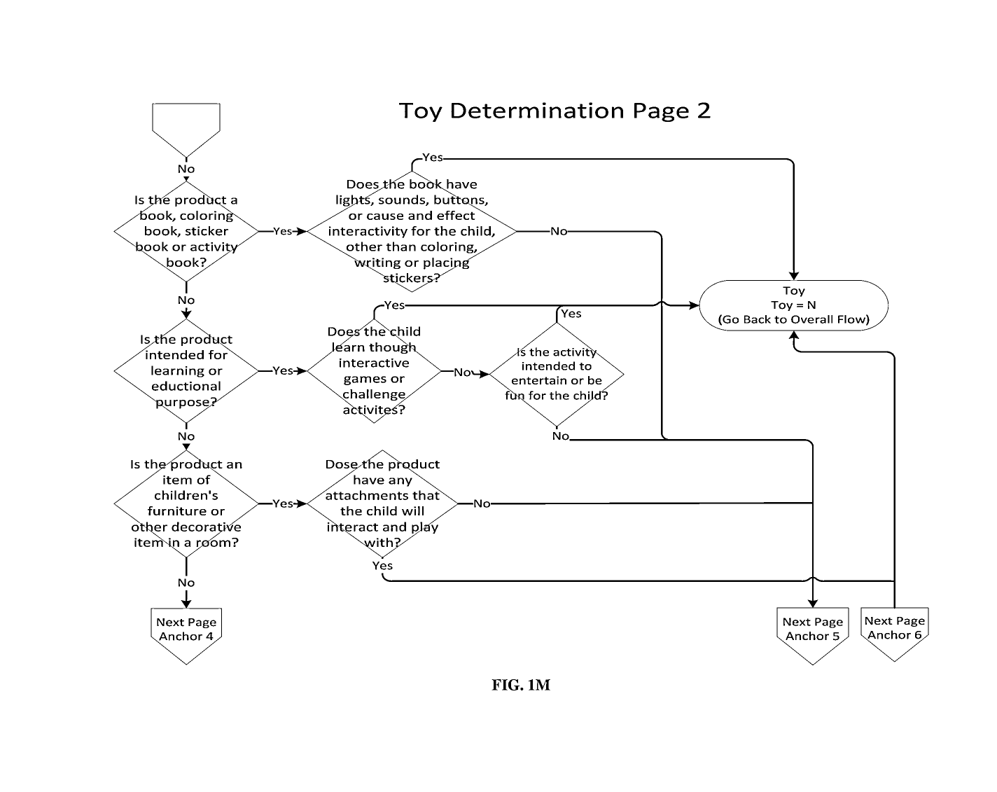

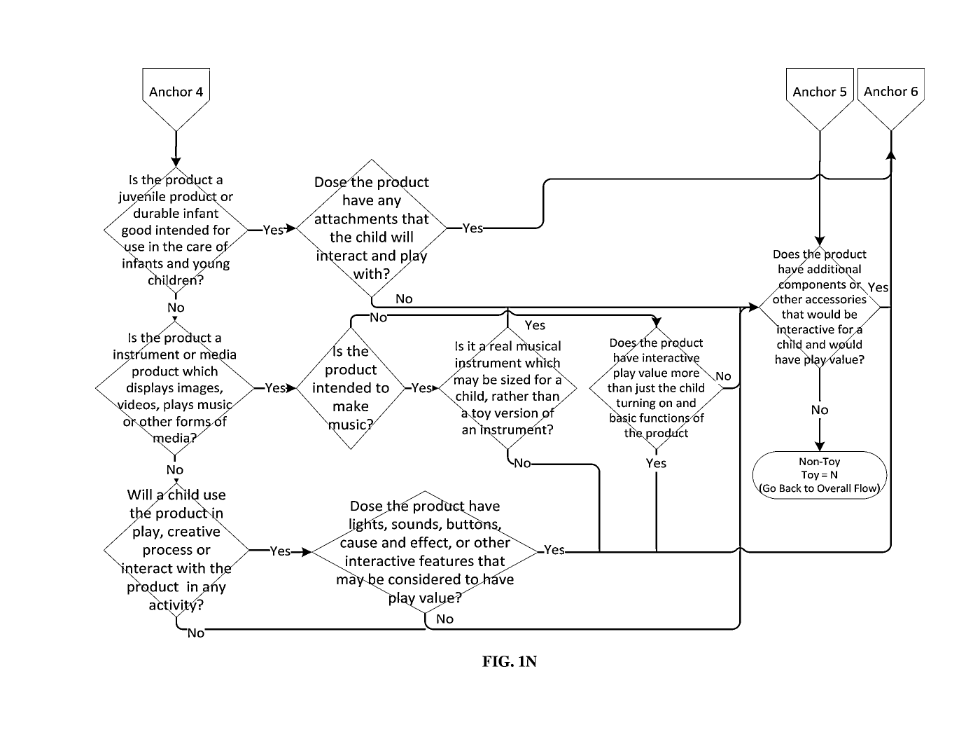

For different categories of product, different sets of test, ban, and/or standard (“rules”) are applicable. The system determines the rules that apply to the new product based on its product category and the answers. FIGS. 1A-1I show the flow charts depicting an exemplary embodiment of the process flow of the product category and applicable rules determination from the answers to the series of questions. The system maintains a database of questions and answer choices, and rules that cross-reference each other for each of the product conformance regulations covered by the system.

The system then identifies the laboratories for performing the conformance tests on the new product demanded by the rules determined. The laboratories identified can be specific laboratories authorized by the conformity certification authority and/or accredited laboratories selected by the user. The system maintains a database of accredited laboratory data including, but not limited to, names, contact information, and cross references to the rules that demand the conformance tests be performed by each laboratory.

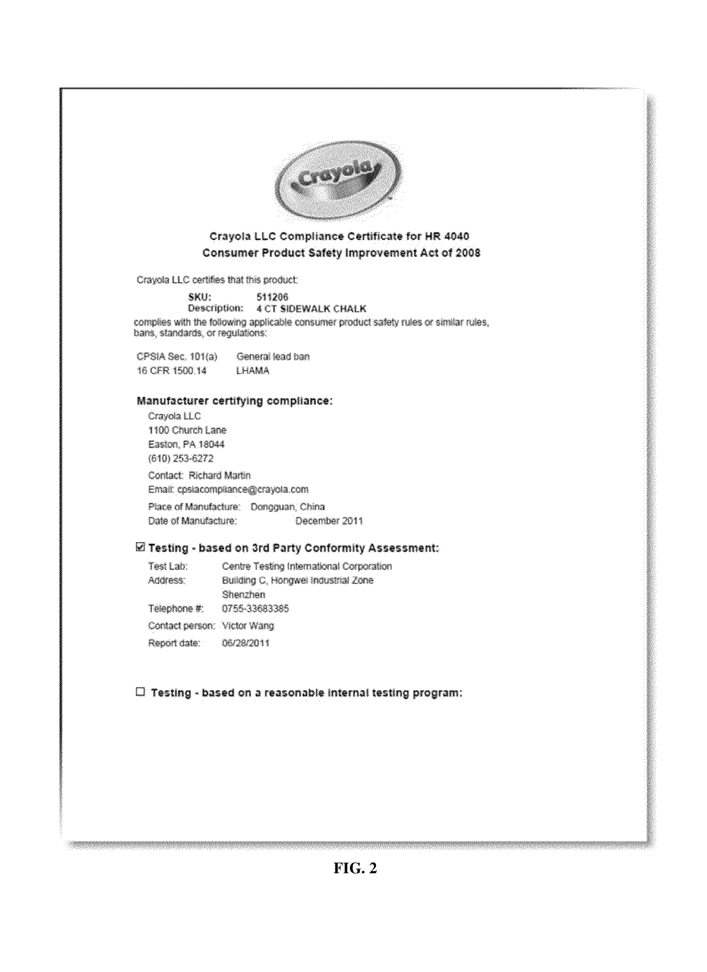

Various documentations of various document types, including, but not limited to, the product specification, product images, and test results, are uploaded to the system. Finally, a general conformity certificate is issued based on the product information, the product category, the rules determined, the laboratories identified, and the documentations uploaded. FIG. 2 shows an exemplary general conformity certificate. The general conformity certificate is stored within the system and made accessible to the user and the conformity certification authority. The system also generates a reference, such as a URL link or a Quick Response (QR) code that would direct an Internet browser to retrieve the electronic copy of the general conformity certificate.

In accordance to one embodiment, the product information and/or documentation can only be completed iteratively on an extended period of time. In this case, a draft general conformity certificate can be issued on incomplete product information and/or documentation. The user can perfect the product information and/or documentation during finalization for the issuance of a formal general conformity certificate. When the formal general conformity certificate is issued, the draft certificate is discarded. Furthermore, the user is allowed to subsequently revise the product information entered and/or documentation uploaded. As such, the system issues a new general conformity certificate based on the new product information and/or documentation.

In accordance to another aspect of the presently claimed invention, the system can accept more information on the new product than that demanded by the generation of the general conformity certificate. The additional information can include production data such as lot size. With the additional information, schedules of periodic/production test can be determined from the rules of the product conformance regulation. Using all the information used in generating the general conformity certificate and the additional information, the system generates a periodic/product test plan document that might be used to satisfy the supplemental documentary requirements of the product conformance regulation, such as the “Reasonable Testing Program” imposed by the CPSIA.

In accordance to yet another aspect of the presently claimed invention, the certification of conformity and product documentation management system provides a workflow assignment automation process for automatically assigning product documentation tasks to different parties when a new product is entered into the system. Each user of the system can configure the level and settings of automation for her account in the system.

In accordance to one embodiment, the user can designate one or more users of the system as Uploaders, Reviewers, and/or Approvers of documents at various stages of the product life cycle for each specified document type and product category. The user decides on the documentation tasks for each document type to be 1-step (review and approval steps are not required), 2-step (after upload, only review or approval step is required), or 3-step (after upload, both review and approval steps are required) process. Uploaders are designated users for uploading the specified documentation such as the test results of certain tests demanded by a rule. As such, an Uploader user can be a supplier of the product. In this case, a supplier can perform its documentation task by using a specially designed user interface (“Supplier Portal”) of the system. Reviewers are designated users for reviewing the uploaded documentation, and Approvers are designated users for approving the uploaded documentation. In addition, the designated users, Uploaders, Reviewers, and/or Approvers, can be registered users (“subscribers”) or unregistered users (“Unsubscribers”) of the system.

In accordance to one embodiment, the workflow assignment automation process comprises the following steps:

1.) The system determines whether a new product being entered into the system should have an automated workflow assigned based on the user's preconfigured settings and the product category of the new product;
2.) The system determines which of new product's documentary requirements should have the automated workflow assigned based on the user's preconfigured settings;
3.) The system determines which of the 1-step, 2-step, or 3-step process for each of the document type as required by the workflow based on the user's preconfigured settings;
4.) The system identifies the Uploaders of each of the document type as required by the workflow based on the user's preconfigured settings and sends notifications, for example in the form of emails, to the Uploaders to upload the documents of the document type; and
5.) For each document type covered by the workflow and under the 2-step or 3-step process, after the uploading of documents, sends notifications to Reviewers and/or Approvers to review and approve the documents uploaded.

The embodiments disclosed herein may be implemented using general purposed or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A computer implemented method for managing product documentation and certification, comprising:
receiving and preserving, by a processing server, product information of a product, wherein the product information comprises product identification and one or more conformance regulations that the product is to comply with;
receiving and preserving, by the process server, one or more answers to one or more questions for categorizing products based on one or more product characteristics;
determining, by the processing server, product category of the product by using the answers to the questions for categorizing products, wherein the product category being selected from an hierarchy of product categories;
determining, by the processing server, one or more rules according to the product category determined and the conformance regulations that the product is to comply with;
identifying, by the processing server, one or more laboratories for performing one or more conformance tests on the product according to the rules determined;
receiving and preserving, by the processing server, one or more documents required by the rules, wherein the documents comprises one or more conformance test results performed by the one or more laboratories identified; and
generating and preserving, by the processing server, a general conformity certificate using the production information, the rules determined, the laboratories identified, and the documents.

2. The method of claim 1, further comprising:
generating, by the processing server, a reference to be used for retrieving the certificate of conformance.

3. The method of claim 2, wherein the reference is a Quick Response Code.

4. The method of claim 1, wherein the hierarchy of product categories is modeled after product categorization requirements of the conformance regulation that the product is to comply with.

5. The method of claim 1, further comprising:
receiving and preserving, by the processing server, one or more updates to the product information, the answers to the questions for categorizing products, and/or the documents; and
generating, by the processing server, a new general conformity certificate using the updated production information, the updated answers to the questions for categorizing products, and/or the updated documents.

6. The method of claim 1, further comprising:
receiving and preserving, by the processing server, additional product information, wherein the additional product information comprises lot size of the product;
determining, by the processing server, a schedule of periodic/production test based on the additional product information; and
generating and preserving, by the processing server, a periodic/production test plan using the production information, the rules determined, the laboratories identified, the documents, and the additional product information, and the schedule of periodic/production test.

7. The method of claim 6, further comprising:
receiving and preserving, by the processing server, one or more updates to the product information, the answers to the questions for categorizing products, the documents, and/or the additional product information; and
generating, by the processing server, a new periodic/production test plan using the updated production information, the updated answers to the questions for categorizing products, the updated documents, and/or the updated additional product information.

8. A computer implemented method for managing product documentation and certification, comprising:
receiving and preserving, by a processing server, configuration of workflow assignment automation settings for each of one or more document types for an automated workflow assigned product category;
receiving and preserving, by the processing server, product information of a product, wherein the product information;
determining, by the processing server, product category of the product;
if the product category of the product is the automated workflow assigned product category:
determining, by the processing server, which of 1-step, 2-step, or 3-step process for each of one or more document types as required by the automated workflow based on the configuration of workflow assignment automation settings;
identifying, by the processing server, and sending a notification to one or more Uploaders for each of the one or more document types as required by the automated workflow to upload one or more documents of the document types;
identifying, by the processing server, and sending a notification to one or more Reviewers for each of the one or more document types as required by the automated workflow with the 2-step or 3-step process to review the one or more uploaded documents of the document types after the documents are uploaded; and
identifying, by the processing server, and sending a notification to one or more Approvers for each of the one or more document types as required by the automated workflow with the 3-step process to approve the one or more reviewed documents of the document types after the documents are reviewed.

9. A system for managing product documentation and certification, comprising a process server configured to execute a process comprises:
receiving and preserving product information of a product, wherein the product information comprises product identification and one or more conformance regulations that the product is to comply with;
receiving and preserving one or more answers to one or more questions for categorizing products based on one or more product characteristics;
determining product category of the product by using the answers to the questions for categorizing products, wherein the product category being selected from an hierarchy of product categories;
determining one or more rules according to the product category determined and the conformance regulations that the product is to comply with;
identifying one or more laboratories for performing one or more conformance tests on the product according to the rules determined;
receiving and preserving one or more documents required by the rules, wherein the documents comprises one or more conformance test results performed by the one or more laboratories identified; and
generating and preserving a general conformity certificate using the production information, the rules determined, the laboratories identified, and the documents.

10. The system of claim 9, wherein the process being executed by the processing server further comprises:
generating a reference to be used for retrieving the certificate of conformance.

11. The system of claim 10, wherein the reference is a Quick Response Code.

12. The system of claim 9, wherein the hierarchy of product categories is modeled after product categorization requirements of the conformance regulation that the product is to comply with.

13. The system of claim 9, wherein the process being executed by the processing server further comprises:
receiving and preserving one or more updates to the product information, the answers to the questions for categorizing products, and/or the documents; and
generating a new general conformity certificate using the updated production information, the updated answers to the questions for categorizing products, and/or the updated documents.

14. The system of claim 9, wherein the process being executed by the processing server further comprises:
receiving and preserving additional product information, wherein the additional product information comprises lot size of the product;
determining a schedule of periodic/production test based on the additional product information; and
generating and preserving a periodic/production test plan using the production information, the rules determined, the laboratories identified, the documents, and the additional product information, and the schedule of periodic/production test.

15. The method of claim 14, wherein the process being executed by the processing server further comprises:
receiving and preserving one or more updates to the product information, the answers to the questions for categorizing products, the documents, and/or the additional product information; and
generating a new periodic/production test plan using the updated production information, the updated answers to the questions for categorizing products, the updated documents, and/or the updated additional product information.
